(19) United States
(12) Patent Application Publication
(10) Pub. No.: US 2022/0355314 A1
(43) Pub. Date: Nov. 10, 2022

(54) MANURE NUTRIENT RECOVERY SYSTEM AND METHOD

(71) Applicant: VALID MANUFACTURING LTD., Salmon Arm (CA)

(72) Inventors: Chad Emery SHIPMAKER, Salmon Arm (CA); Jesse Kord MCCUTCHEON, Salmon Arm (CA); Grant Warren MEIKLE, Salmon Arm (CA); Kurt Alexander MELNEY, Salmon Arm (CA)

(21) Appl. No.: 17/739,000

(22) Filed: May 6, 2022

Related U.S. Application Data
(60) Provisional application No. 63/185,191, filed on May 6, 2021.

(30) Foreign Application Priority Data
May 6, 2021 (CA) 3117301

(51) Int. Cl. B04B 5/10; B04B 1/20; B04B 11/02; B02C 23/10; C05F 3/06

(52) U.S. Cl. CPC B04B 5/10; B04B 1/20; B04B 11/02; B02C 23/10; C05F 3/06; B04B 2005/105

(57) ABSTRACT

A system for extracting nutrients from raw manure comprises: a manure pump for transferring manure from a reception pit to a rotary cutter configured to cut fibers of the raw manure to a desired length to generate a manure slurry. The manure slurry is transferred to a preprocessing tank having an agitator for agitating the manure slurry. An infeed pump transfers the manure slurry from the preprocessing tank to a decanter centrifuge, the centrifuge having at least one solid outlet and at least one liquid outlet. A control system controls a flow of the raw manure from the manure pump to the rotary cutter, and from the rotary cutter to the preprocessing tank, the infeed pump and the decanter centrifuge, and also controls each of these elements of the system. A nutrient content of the resulting liquid centrate is reduced by at least 50% as compared to the raw manure.

### CROSS-REFERENCE TO RELATED APPLICATIONS

This application claims the benefit of U.S. Provisional patent application No. 63/185,191 and Canadian patent application no. 3,117,301, both filed on May 6, 2021 and entitled “Manure Nutrient Recovery System”, all of which are incorporated herein by reference.

### FIELD

The present application relates to systems and methods for recovering nutrients from agricultural manure; in particular, the present application relates to systems and methods for the separation of raw manure into a solid cake and a liquid centrate, wherein the phosphorous (or other nutrient) content is reduced in the liquid centrate and increased in the solid cake.

### BACKGROUND

There exists an over nutrient application problem in agricultural areas, caused by livestock farmers spreading manure over their land. Traditionally, farmers will distribute all accumulated raw manure over their fields to fertilize and to help mitigate the overabundance of manure on a dairy farm or other livestock farm. However, the traditional method of distributing raw manure over fields may cause the buildup of excess nutrients, such as phosphorous, over time, depending on the characteristics of the land and the raw manure being distributed over the land. As a result, excess phosphorous or other nutrients, such as nitrate, potassium or calcium, may migrate into the water table, with the resulting nutrient enrichment causing excessive algae blooms and overall water contamination.

To address this issue, various technologies and methods have been deployed in an attempt to reduce the nutrient content of raw manure, before the manure is spread onto field for fertilizer. To the Applicant's knowledge, some existing manure handling systems utilize large decanter centrifuges to dewater the raw manure, resulting in a solid fraction and a liquid fraction, wherein the liquid fraction has a reduced phosphorous content and may thereafter be spread onto the fields. However, such large decanter centrifuges are expensive to purchase and maintain and require active monitoring by a worker. As a result, such systems are typically only used on large farming operations; for example, such systems may be deployed on cattle farms having at least 1,000 head of cattle. Additionally, the raw manure feed is processed to remove a significant portion of the solids before the raw manure is fed into the decanter centrifuge, for example by screening the raw manure or feeding the raw manure through a screw press. This step of removing a portion of the solids from the raw manure before feeding the raw manure through the centrifuge is to avoid clogging or overloading the centrifuge, which may occur due to the high fiber content that is typically found in the raw manure.

In other systems, of which the Applicant is aware, U.S. Pat. No. 10,266,440 to Assadi discloses an anaerobic digestion system for processing manure, agricultural waste and wood waste, the system comprising an anaerobic digestion system including a material grinding portion, a hydrolysis portion arranged downstream of the grinding portion, a multiple chamber anaerobic reactor arranged downstream of the hydrolysis portion and including a gas collection and reintroduction system, a collection system for collecting digestate and gas from the anaerobic reactor. The solid digestate may be used as a soil conditioner and the liquid digestate may be used as a liquid fertilizer, while the biogas harvested from the anaerobic digestion system may be used to generate electricity.

U.S. Pat. No. 9,611,158 to Earth Renewal Corp. LLC discloses a process for treating waste, including a sewage organic feedstock, by reacting the feedstock in a reactor. The reaction mixture includes the feedstock, a first oxidizing acid and nitric acid. The resulting liquid component, having reduced phosphorous content and increased nitrogen content, may require further treatment to remove heavy metals before it may be used as a liquid fertilizer.

U.S. Pat. No. 10,737,958 to the United States of America and the Penn State Research Foundation discloses methods for treating high phosphorous fluid, involving chemically treating liquid to transform the dissolved phosphorous into a solid form via sorption of phosphorous onto particles placed into or precipitated within the liquid stream; and removing the solid form phosphorous from the chemically treated fine solids stream.

International Patent Publication No. WO 94/20436 to Van Merkstein describes a method for processing manure by separating the manure into at least a solid fraction and a liquid fraction using a centrifuge. The solid fraction, after separation, may still contain 20-60% water by weight. The solid fraction is then composted to make it suitable as a fertilizer or a nutrient. The liquid fraction is also further processed by a bacteriological cleaning station in the form of a clamp silo.

### SUMMARY

The Applicant herein provides, in one aspect of the present disclosure, a system and method for efficiently separating the solid and liquid fractions of a manure feedstock and increasing the phosphorous (or other nutrient) content in the solid fraction, wherein the raw manure is fed directly into the system without first screening the raw manure to remove a portion of the fibrous solids. Advantageously, the system may be designed at a smaller scale compared to other centrifuge-based manure separation systems, because the system includes a cutting apparatus that processes the raw manure feedstock to break down the fibrous material to a uniform size range, and then agitating the broken down raw manure feedstock so at to create a homogenous manure slurry, prior to feeding the manure slurry into a decanter centrifuge for separation of the solids from the liquids.

In one aspect, because the raw manure feedstock is preprocessed to create a homogenous manure slurry having fibrous material in a consistent range of lengths, the Applicant has discovered that the smaller-scale decanter centrifuge is capable of handling the manure slurry to efficiently separate the solids from the liquids without clogging the decanter centrifuge. For example, the manure slurry may contain up to approximately 50% solids, compared to typical centrifuge-based systems where the solids content is reduced to approximately 20-25% before it is fed into the centrifuge. Advantageously, because the entire solids content of the raw manure is fed into the separation system, the Applicant has found that a higher amount of phosphorous is removed from the liquid fraction, as the dissolved phosphorous tends to bind to the solid particles in the slurry. Furthermore, the Applicant has found that a higher amount of fine organic materials are recovered in the solid fraction, which fine organic materials are useful in soil amendment products and may therefore increase the value of the recovered solid fraction.

Advantageously, the systems and methods described above may be designed for autonomous operation, whereby the system may run continuously for several weeks before servicing and maintenance is required. The system includes a control system, which utilizes sensors, controllers and/or processors to monitor the loads in the cutting apparatus and the decanter centrifuge, as well as the levels of the manure slurry contained in the preprocessing tank, so as to control the speeds or operation of the manure pump, cutting apparatus, infeed pump and centrifuge, to compensate for variations in the density, viscosity, and other characteristics of the raw manure feed, which vary over time.

In one aspect of the present disclosure, a system for extracting nutrients from raw manure comprises: a cutting apparatus for receiving raw manure from a manure reception pit and configured to cut fibers of the raw manure to a desired length to generate a manure slurry. The manure slurry is transferred to a preprocessing tank having an agitator for agitating the manure slurry. An infeed pump transfers the manure slurry from the preprocessing tank to a decanter centrifuge, the centrifuge having at least one solid outlet and at least one liquid outlet. A control system controls a flow of the raw manure from the manure pump to the rotary cutter, and from the rotary cutter to the preprocessing tank, the infeed pump and the decanter centrifuge, and also controls each of these elements of the system. A phosphorous content of the resulting liquid centrate, in some embodiments, may be reduced by at least 50% as compared to the raw manure.

In one aspect, a nutrient recovery system for extracting at least one nutrient from raw manure received from a manure pump is provided. The system comprises a cutting apparatus having an inlet in fluid communication with the farm's manure pump and an outlet, the cutting apparatus for cutting fibers of the raw manure to a desired length so as to generate a manure slurry. The outlet of the cutting apparatus is in fluid communication with an inlet of a preprocessing tank, the preprocessing tank for receiving the manure slurry and comprising an agitator for homogenizing the manure slurry in the preprocessing tank. An infeed pump is in fluid communication with an outlet of the preprocessing tank, the infeed pump for transferring the manure slurry from the preprocessing tank to a decanter centrifuge, the decanter centrifuge having at least one solid outlet for directing a solid cake of the manure slurry into a solids receptacle and at least one liquid outlet for directing a liquid centrate of the manure slurry into a liquid receptacle. A control system comprises a plurality of controllers and sensors, the control system for controlling at least a flow rate of the manure slurry entering the decanter centrifuge and for controlling the operation of motorized components of the system including the manure pump, the cutting apparatus, the infeed pump and the centrifuge to avoid blockages or overloading of any component of the system. A nutrient content of the at least one nutrient in the liquid centrate is decreased as compared to the raw manure.

In some embodiments, the at least one nutrient is selected from a group comprising: phosphorous, potassium, calcium, fine organic solids. In some embodiments, the at least one nutrient includes phosphorous and a phosphorous content of the liquid centrate is decreased by at least 50% by volume as compared to the raw manure. In some embodiments, the desired length of the fiber is in the range of 0.0625 inches to 1 inch.

In some embodiments, the cutting apparatus includes a motor controlled by a speed control mechanism, the speed control mechanism in electronic communication with the control system, wherein a speed of the cutting apparatus motor is adjusted by the cutting apparatus speed control mechanism based on a load of the cutting apparatus, the load of the cutting apparatus detected by the control system by monitoring a status of the cutting apparatus motor. In some embodiments, the monitoring of the status of the cutting apparatus motor is selected from a group comprising: monitoring the current draw of the cutting apparatus motor, monitoring the torque of the motor.

In some embodiments, the infeed pump comprises an infeed pump motor controlled by an infeed speed control mechanism, the infeed speed control mechanism in electronic communication with the control system, and when the control system detects a higher load on the decanter centrifuge the infeed speed control mechanism gradually decreases the infeed motor frequency to decrease the flow rate of the manure slurry into the decanter centrifuge, and wherein when the control system detects a decreased load on the decanter centrifuge the infeed speed control mechanism gradually increases the infeed pump motor frequency to increase the flow rate of the manure slurry into the decanter centrifuge, so as to compensate for variations in manure slurry viscosity.

In some embodiments, the tank includes a fluid inlet for introducing water or liquid centrate to the preprocessing tank and a level sensor for measuring an amount of manure slurry contained in the preprocessing tank, the level sensor in electronic communication with the control system, wherein when the load on the decanter centrifuge exceeds a threshold, the control system introduces water or liquid centrate to the preprocessing tank through the fluid inlet so as to decrease the viscosity of the manure slurry entering the decanter centrifuge. The infeed speed control mechanism may be, for example, a variable frequency drive (VFD). The preprocessing tank may include a level sensor for measuring an amount of manure slurry contained in the preprocessing tank, the level sensor in electronic communication with the control system, and when the level sensor detects the amount of manure slurry in the preprocessing tank is below a lower threshold the control system initiates the manure pump and cutting apparatus, and wherein when the level sensor detects the amount of manure slurry in the preprocessing tank is above an upper threshold the control system stops the manure pump and the cutting apparatus. The cutting apparatus may be selected from a group comprising: a rotary cutter, a grinder, a macerator.

In some embodiments, the manure pump includes a motor controlled by a manure pump speed control mechanism and a flow meter, and the cutting apparatus is controlled by a cutting apparatus speed control mechanism, and wherein a flow rate of the raw manure entering the cutting apparatus is controlled by adjusting a speed of the manure pump motor to correspond to the speed of the rotary cutter motor. The preprocessing tank may include a level sensor for measuring an amount of manure slurry contained in the preprocessing tank, the level sensor in electronic communication with the control system, wherein the manure pump speed control mechanism increases the speed of the manure pump motor when the level sensor detects the amount of manure slurry in the preprocessing tank is below a lower threshold, and wherein the manure pump speed control apparatus decreases the speed of the manure pump motor when the level sensor detects the amount of manure slurry in the preprocessing tank exceeds an upper threshold. In some embodiments, the lower threshold of the level sensor is set at a first height measured from a floor of the preprocessing tank, wherein the first height extends above a blade height of the agitator, the blade height measured from the floor of the preprocessing tank to the upper surface of the agitator, and wherein the upper threshold of the level sensor is set at a second height measured from the floor of the preprocessing tank, wherein the second height is greater than the first height and less than a total height of the preprocessing tank.

In some embodiments, the control system further comprises a centrifuge overcurrent detector, wherein the centrifuge overcurrent detector monitors a main drive current of a centrifuge main drive motor and a back drive current of a centrifuge back drive motor of the decanter centrifuge, and wherein when the main drive current or the back drive current exceeds a centrifuge current threshold, the control system temporarily stops the infeed pump until the manure slurry in the centrifuge has exited the centrifuge, at which time the control system reinitiates the infeed pump.

In some embodiments, a method for extracting at least one nutrient from raw manure, the raw manure transferred from a manure reception pit into the system by a manure pump, is provided. The method includes the steps of:
transferring raw manure to a cutting apparatus, the cutting apparatus having an inlet in fluid communication with the manure pump and an outlet, the cutting apparatus for cutting fibers of the raw manure to a desired length so as to generate a manure slurry,
transferring the manure slurry to a preprocessing tank, the preprocessing tank comprising an agitator for homogenizing the manure slurry in the preprocessing tank,
transferring the homogenized manure slurry via an infeed pump to a decanter centrifuge, the decanter centrifuge having at least one solid outlet for directing a solid cake of the manure slurry into a solids receptacle and at least one liquid outlet for directing a liquid centrate of the manure slurry into a liquid receptacle,
controlling at least a flow rate of the manure slurry through the infeed pump to the decanter centrifuge by a control system so as to prevent blockage or jamming of the decanter centrifuge, and
wherein a nutrient content of the at least one nutrient in the liquid centrate is decreased as compared to the raw manure.

In some embodiments, the method further comprises the step of controlling a level of manure slurry inside the preprocessing tank by detecting the said level of manure slurry inside the tank, using a level sensor, and turning on the cutting apparatus motor and the manure pump motor by the control system when the detected level of manure slurry inside the tank is below a lower threshold and turning off the cutting apparatus motor and the manure pump motor by the control system when the detected level of manure slurry inside the tank is above an upper threshold.

### BRIEF DESCRIPTION OF THE DRAWINGS

FIG. 1 is a schematic drawing, illustrating different configurations of manure handling systems on farms.

FIG. 2A is a schematic drawing, illustrating the two sub-systems of the nutrient recovery system in accordance with an embodiment disclosed herein.

FIG. 2B is a schematic drawing, illustrating different configurations of the preprocessing sub-system of FIG. 2A.

FIG. 2C is a schematic drawing, illustrating different configurations of the centrifuge sub-system of FIG. 2A.

FIG. 3 is a top elevation view of an embodiment of the preprocessing sub-system.

FIG. 4 is a perspective view of the embodiment of the preprocessing sub-system shown in FIG. 3.

FIG. 5 is a sectional view of an embodiment of a cutting apparatus.

FIG. 6 is a perspective view of an embodiment of the centrifuge sub-system.

FIG. 7 is a side elevation view of the embodiment of the centrifuge sub-system shown in FIG. 6.

FIG. 8 is a sectional view of an embodiment of a decanter centrifuge.

### DETAILED DESCRIPTION

### Overview

The Applicants have found that keeping all of the solids in the raw manure feed that is separated in the centrifuge, advantageously increases the amount of phosphorous that is recovered in the solid fraction and removed from the liquid fraction, as compared to using a raw manure feedstock that has a lower solid content by pre-screening a portion of the solids prior to centrifuging the raw manure. In part, this is because the solids in the raw manure provide binding sites for the phosphorous, and therefore by creating a manure slurry having a high solids content, more of the phosphorous is removed from the liquid fraction of the manure slurry. Although the nutrient phosphorous is described herein as an illustrative example of a nutrient recovered by the systems and methods disclosed herein, the term “nutrient” as used herein also refers to other nutrients that may be present in a raw manure and which tend to bind to solids, in that separating a raw manure slurry having an increased solids content may result in greater removal of that nutrient from the liquid centrate; and conversely, the term “nutrient” may also include nutrients that tend not to bind to solids and stay in solution, in which case the process of nutrient separation may also include, in some applications, removing a nutrient from the solid fraction to concentrate that nutrient in the liquid fraction obtained after the manure slurry is passed through the centrifuge. Additionally, the term “nutrient” includes fine organic solids which are useful for promoting plant growth.

A further advantage of feeding the entirety of the raw manure, including 100% of the solids contained therein, through the manure handling system, is that this process allows the farmer to process all of the raw manure, without having to divert a portion of the screened-out solids to a storage pit or to a composter to create usable soil amendment. Additionally, because the dry solid cake that exits the decanter centrifuge contains a higher phosphorous content, the dry solid cake may be a valuable by-product of the process that may be either used on-site as fertilizer, or may be sold to a fertilizer manufacturer. The increased phosphorous separation additionally results in less phosphorous content in the liquid centrate that exits the centrifuge, such that the liquid centrate may be directly applied to fields as fertilizer where excess phosphorous content is a concern. In some embodiments, for example, the systems and methods disclosed herein may produce a liquid centrate having at least 50% less phosphorous by volume, or alternatively by weight, as compared to the raw manure.

In view of the increased separation efficiency of running the full solids content of the raw manure through a decanter centrifuge, the Applicant's methods and systems need to address the issues of having a high solids content in a feedstock for a centrifuge, and in particular for a smaller centrifuge that would be suitable for handling manure on smaller farming operations. Typical decanter centrifuges do not handle slurries with a solids content exceeding 25% by volume, without causing problems with the centrifuge, such as clogging or excessive vibration. In contrast, when using the system and methods described herein, a smaller capacity decanter centrifuge, which may be an off the shelf component, is capable of handling manure slurries in the range of 25% to 40% solids content.

An example of a small sized decanter centrifuge used in the Applicant's systems is the model DX200 manufactured by Allied Centrifuge, which is typically operated in the Applicant's systems at a flow rate of approximately 8 to 10 Gal/min. Such a flow rate is suitable for handling a small to medium sized dairy farm having 125 to 250 milking cows, otherwise referred to in the industry as “milking cow units”. A milking farm operation having 125 to 250 milking cow units would produce approximately 20,000 to 40,000 liters per day of manure that would be processed through the centrifuge of the nutrient recovery system disclosed herein. The range of the volume of manure stated above is an estimate only, and it may be more or less depending on the amount of water content in the manure at a given farming operation. In another aspect of the present disclosure, the nutrient recovery systems disclosed herein may also be scaled up for larger farm operations; for example, by running two or more centrifuges of the same size in parallel. Advantageously, the ability to scale the manure handling system of the present disclosure would allow a farmer to implement the system when the herd is a smaller size, and then as the farming operation grows in size, the same system may be scaled up by adding additional centrifuges to handle the increased manure volume. The small size and future scalability of the system, therefore, provides a system that is economical and practical for implementation by small and medium sized farming operations. Although examples described herein refer to dairy operations, it will be appreciated by a person skilled in the art that the systems and methods disclosed herein may also be employed by other types of livestock farmers who need to handle manure to separate phosphorous from the liquid, including but not limited to pig, sheep and goat farms or any combination thereof of different types of livestock.

In another aspect of the present disclosure, the smaller scale decanter centrifuge is capable of handling a manure slurry having a solids content of up to 40% by volume, due to the preprocessing of the raw manure to reduce the fiber length to a desired, uniform length and homogenizing the manure slurry, before it is fed into the decanter centrifuge. As used herein, the term “uniform length” refers to a fiber size in a manure slurry that is equal to or less than the desired fiber length, which desired fiber length may be in the range between 1/16 of an inch and one inch long.

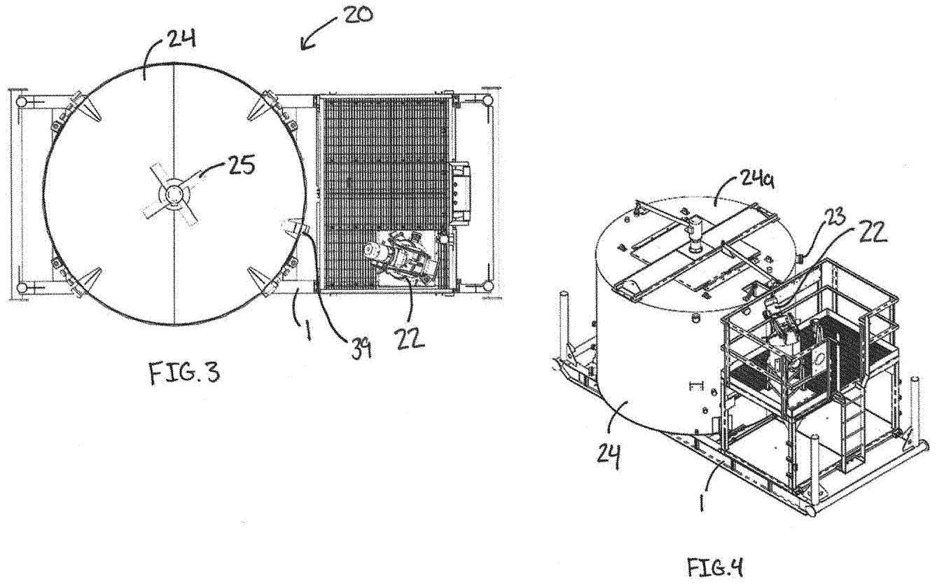

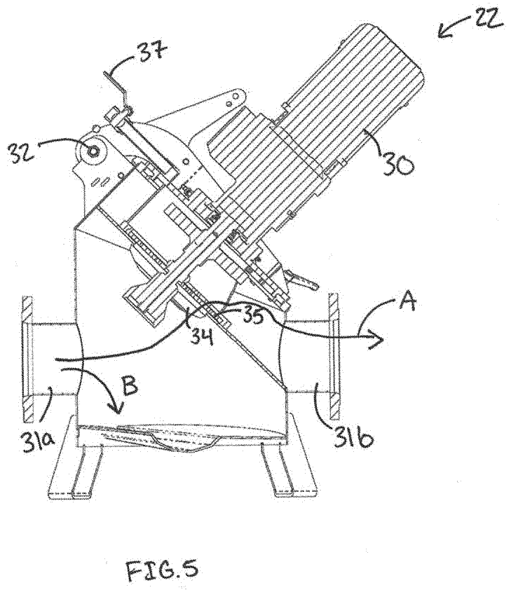

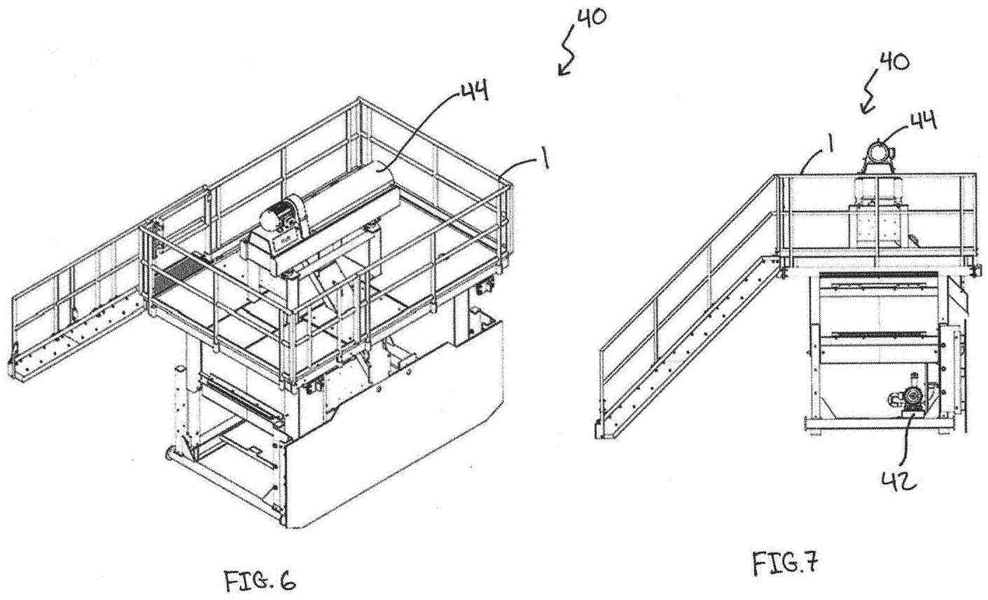

The preprocessing of the raw manure includes pumping the raw manure into a cutting apparatus, which in some embodiments is a rotary cutter 22 as shown in FIG. 5. For embodiments incorporating a rotary cutter 22, the size of the processed fibers is controlled by the flow rate of the raw manure fed into the rotary cutter through inlet 31a, the speed of rotation of the rotary cutter blades 34, and the size of the screen 35 incorporated in the rotary cutter. The screen 35 inside the rotary cutter is downstream of the rotary cutter blades 34, and thus only particles of a given size are able to pass through the screen, based on the size of the screen apertures. For example, not intended to be limiting, the screen apertures may have a width or diameter of 10 mm. With respect to the speed of rotation of the rotary cutter blades, a faster rotation speed results in a smaller fiber size. In some embodiments, the resulting fiber length may be in the range of 1/16 inches to 1 inch (1.6 mm to 25 mm). As best viewed in FIG. 5, the raw manure has a flow path A, whereby the raw manure enters the cutter 22 through inlet 31a, passes through the rotary cutting blades 34 driven by motor 30, and then pass through the screen 35 and through the outlet 31b.

The apertures in the screen 35 may be sized so as to only allow particles or fibers of the desired length pass through the screen 35. As shown by arrow B, the occasional solid contaminants that may enter the raw manure stream will settle out at the bottom of the cutting apparatus 22 and may be removed during maintenance. Solid contaminants may include, but are not limited to, chunks of wood, rocks or bones, as well as nails or other metallic debris that may fall into the manure reception pit. The cutting apparatus 22 may also include a water valve 37, for introducing water or centrate to the rotary cutter for cleaning or maintenance purposes, or to clear a blockage from the apparatus. Although the cutting apparatus is a rotary cutter in the illustrative examples described herein, other suitable cutting apparatuses include but are not limited to maceraters, grinders, or any other component capable of processing raw manure to create a manure slurry having a desired fiber length.

Optimal fiber length is specific to each farm facility and is determined during the startup phase of system installation. Each farm facility will have different types of solids content which may include, for example, wood, straw or sand. Preferably, the system will be configured to provide the largest fiber length that will allow for the entire system to run well without plugging, because longer fiber lengths may provide greater potential for phosphorous or other nutrients to adhere to the solids during the nutrient separation process. The raw manure may be fed directly into the rotary cutter or other cutting apparatus by a manure pump. In some embodiments, the system may be designed to work with a farm's existing manure pump, whereas in other embodiments, the system may include a manure pump.

After processing by the cutting apparatus to reduce the fiber size to a desired length, the resulting manure slurry exits the cutting apparatus 22 through outlet 31b and proceeds to the preprocessing tank 24 via inlet 39. The preprocessing tank includes an agitator 25 for agitating the manure slurry, and level sensors to indicate the level of manure held in the preprocessing tank. The agitator homogenizes the incoming manure slurry received from the cutting apparatus. As will be appreciated, the characteristics of the raw manure feedstock, including the relative solids and liquids content, and the amount of fiber and other substances, such as sand and silt, will be variable as the raw manure is removed from the holding pit 2 by the manure pump. Thus, the resulting manure slurry may vary in viscosity over time. The agitator in the preprocessing tank is constantly agitating and mixing the manure slurry held in the tank, so as to homogenize the manure slurry inside the tank and maintain the fibers suspended in the slurry. Advantageously, the characteristics of the manure slurry that exits the tank will experience gradual changes in viscosity and other characteristics over time, as opposed to experiencing sudden changes in viscosity or other characteristics. As will be further explained below, this gradual change in the slurry characteristics over time allow the control system to detect such changes and accordingly adjust the infeed pump and the decanter centrifuge to avoid clogging or unbalancing the decanter centrifuge. Optionally, the preprocessing tank may include inlets for introducing water and/or liquid centrate into the preprocessing tank, for farm operations that may not have sufficient liquid content in the manure slurry, or to adjust the viscosity or density of the manure slurry when needed to avoid clogging the centrifuge.

The level sensors on the preprocessing tank 24 may be used to determine when the preprocessing tank is nearly empty or nearly full. Signals from the level sensors are fed into the control system, which may then be used to either speed up or slow down the flow rate of the raw manure through the cutting apparatus to maintain the volume of manure slurry in the preprocessing tank at an ideal level. For example, the upper level threshold of the preprocessing tank may be set at 80% of the total capacity of the tank, and the lower level threshold of the preprocessing tank may be set at a height within the tank that exceeds the height of the agitator blades, so that the level of slurry manure inside the tank is maintained at a level sufficient to submerge the agitator in the slurry and constant slurry agitation occurs. Examples of level sensors include but are not limited to pressure sensors, ultrasound sensors, float sensors, laser sensors, light sensors, capacitance sensors and inductive sensors.

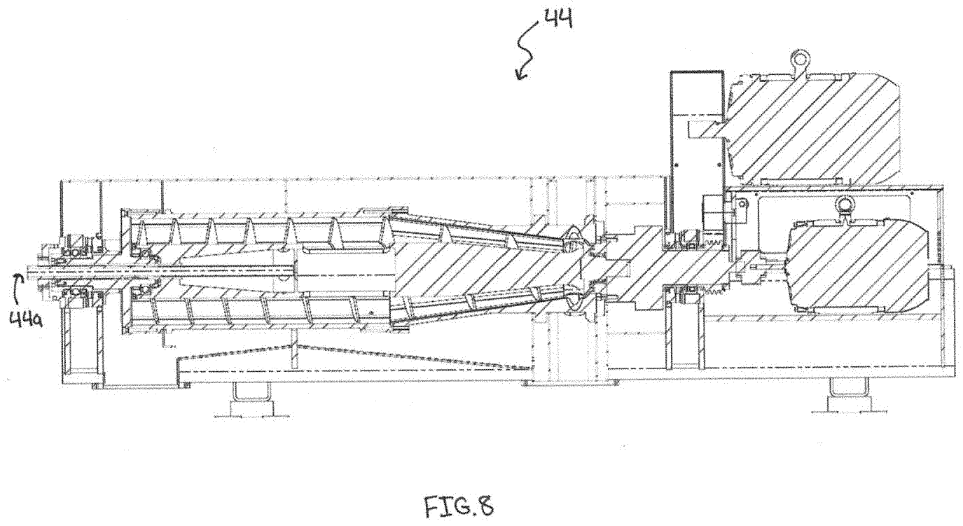

The manure slurry is transferred from the preprocessing tank to the decanter centrifuge 44 by an infeed pump 42 via centrifuge inlet 44a, which inlet for example may have a one inch diameter. The decanter centrifuge 44 may be an off the shelf component as would be known to a person skilled in the art, such as the decanter centrifuge 44 illustrated in FIG. 8. The centrifuge 44 and infeed pump 42 may also be mounted on a skid 1 for ease of transportation and placement on the farm site. During the initial startup and installation phase an optimal centrifuge speed range is determined for both the outer bowl and screw of the centrifuge. The optimal centrifuge speed range is set so as to maximize nutrient separation while still allowing proper function of the centrifuge. The infeed pump 42 is configured to adjust its flow rate, depending on whether the centrifuge is operating at under capacity or over capacity, as may be determined by monitoring the current draw and/or the torque of the main and back drive motors of the decanter centrifuge. For example, if the system is processing higher density slurry, the current draw will increase on the centrifuge main and back drives, and the control system will detect the increased current draw and automatically slow down the infeed pump to compensate for this influx in slurry density. In other embodiments, the torque on the bowl and the screw of the centrifuge may be monitored to detect increased slurry density. Additionally, the bowl speed and screw speed of the centrifuge may each be adjusted to promote better solids separation and overall centrifuge function. With the control system, a dynamic feed and speed system is provided which may adjust the different system components automatically to handle fluctuations in the slurry density and other characteristics, thereby allowing for continuous and autonomous operation around the clock.

In one aspect, the nutrient recovery systems and methods disclosed herein are configurable to work on any existing livestock farm. Elements of the system that may be added or changed include, but are not limited to redundant overflow lines, bypasses to allow previous operation of the pre-existing manure handling system without the nutrient recovery system where maintenance is required, optional systems for adding liquid to the preprocessing tank, and/or one or more additional decanter centrifuges to run in parallel. Preferably, the nutrient recovery system may be configured to operate autonomously 24 hours a day, seven days a week, for several weeks before requiring maintenance. As such, in one aspect a remote monitoring and fault alert system is provided, whereby the operator can log onto a website and review live device status, faults, configurations and historical data. The operator may be alerted by the monitoring system by electronic means, including but not limited to email or text message alerts, so as to alert the operator of a fault in the system in real time.

In another aspect, the nutrient recovery system may be a modular system with the components mounted on skids, which, when combined, form a full nutrient recovery system. The nutrient recovery system is comprised of two major sub-systems: the preprocessing system, which includes the cutting apparatus and the preprocessing tank, and the centrifuge system, which comprises the infeed pump and the decanter centrifuge.

### Farm Configurations

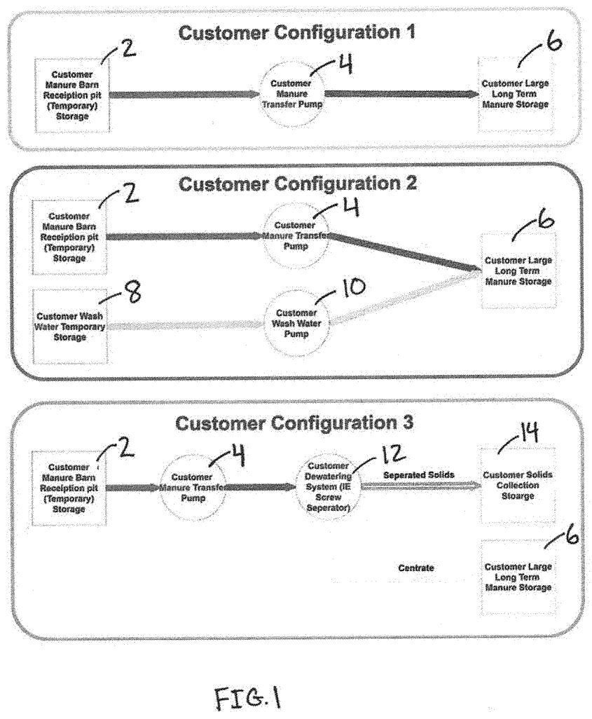

As shown in FIG. 1, three different configurations showing typical dairy farm manure handling systems are illustrated. In customer configuration 1, the manure reception pit 2, which is typically located adjacent the barn, is in fluid communication with a manure transfer pump 4. The manure transfer pump 4 transfers the raw manure from the reception pit 2 to a larger, long term manure storage pit 6. In customer configuration 2, in addition to the manure reception pit 2 adjacent the barn, there is also a wash water storage pit 8, which receives wash water from the barn. In such a configuration, the farm may have both a manure transfer pump 4 and a wash water pump 10, with the wash water pump 10 transferring the wash water from the wash water storage pit 8 to the long term manure storage pit 6. In customer configuration 3, the manure transfer pump 4 transfers manure from the manure reception pit 2 to a dewatering system 12, which may be a screw separator having a solids outlet and a liquids outlet. The solids are delivered via a solids line 12a to a solids collection pit 14, and the liquids are delivered via a liquid centrate line 12b to the long term manure storage pit 6, which liquids may still contain fine solids that were not separable by the dewatering system.

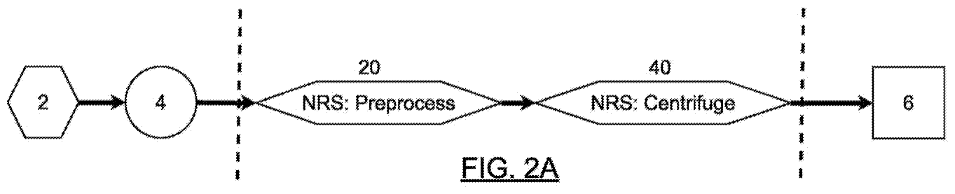

As illustrated in the overview schematic drawing of FIG. 2A and the detailed schematic drawings of FIGS. 2B and 2C, the nutrient recovery system disclosed herein may be installed to operate in conjunction with the customer's existing manure handling system. The farm's existing manure transfer pump 4 may be used to transfer raw manure from the manure reception pit 2 to the preprocessing subsystem 20, which processes the raw manure into a manure slurry. The manure slurry is then transferred to the centrifuge subsystem 40, where the solids are separated from the liquids in a decanter centrifuge, and then the liquid centrate may be transferred to the existing large long term manure storage pit 6, or may optionally be transferred to a storage tank for later use as a liquid fertilizer. The solids may similarly be transferred to a receptacle, for storage or later use.

In FIGS. 2B and 2C, various different configurations of the nutrient recovery system are shown, with optional configurations shown in dotted outlines depending on the specific farm site. Details of the preprocessing sub-system are illustrated in FIG. 2B and details of the centrifuge sub-system are illustrated in FIG. 2C. For a farm site configuration 1 as shown in FIG. 1, the manure reception pit 2 is in communication with level sensors, such as overflow and bottom level sensors 3a, 3b, which sensors are in communication with the control system and would be used in automating the continual operation of the system, such as to detect when to start a new feed of raw manure into the nutrient recovery system based on the level of raw manure in the manure reception pit 2. The customer manure pump 4 transfers raw manure to the cutting apparatus 22 of the preprocessing subsystem 20, where the fibers of the raw manure material are cut up to the desired length, generating a manure slurry. Optionally, the customer manure pump 4 may include manure bypass line 7a to redirect manure to a screw separator 12, for an existing site having a screw separator such as in customer configuration 3 of FIG. 1, and/or a manure bypass line 7b may redirect manure to the long term manure storage pit 6.

After the raw manure slurry is generated by the cutting apparatus 22, the manure slurry is then transferred to the preprocessing tank 24, where an agitator 25 continuously stirs the manure slurry. Level sensors, which for example may include an overflow level sensor 26a, an operating level sensor 26b and a bottom level sensor 26c, are deployed to monitor the level of manure slurry in the tank 24 and communicate the detected levels to the control system. The level sensors 26a, 26b, 26c may be any type of sensor capable of detecting the level of manure slurry inside the tank. In some embodiments, it will be appreciated that a single level sensor may be deployed to monitor when the manure slurry reaches different levels inside the tank, measured as a height from the floor of the tank. For example, a single level sensor may be an ultrasonic sensor which may advantageously detect the level of manure slurry inside the tank, and will distinguish between froth or foam and the actual level of the fluid slurry inside the tank.

The manure slurry is transferred from the preprocessing tank 24, by the infeed pump 42 of the centrifuge sub-system 40, to the decanter centrifuge 44. A flow meter 43, in line between the infeed pump 42 and the centrifuge 44, detects the flow rate of the manure slurry being transferred to the centrifuge, and is in communication with the control system. The decanter centrifuge 44 includes a main drive motor 45a and a back drive motor 45b. The operation of the centrifuge is also monitored by different sensors in communication with the control system, including for example the vibration sensor 46a, the liquid exit bearing temperature sensor 46b and the solid exit bearing temperature sensor 46c. The solids exiting the centrifuge 44 are transferred to a dewatered solids storage 14 (and the transfer of the solids from the centrifuge 44 to the solids storage 14 may optionally be accomplished using an auger 44a), and the liquid centrate exiting the centrifuge is transferred to the long term manure storage pit 6. Alternatively, the liquid centrate may be transferred to a centrate tank 50 for later use, such as a liquid fertilizer, or the liquid centrate may also be routed to other parts of the system, such as via a centrate return line 54 to a customer's pre-existing wash water system (ie: customer configuration 2 shown in FIG. 1), which pre-existing wash water system may include wash water and centrate tank 52 for supplying liquids to the cutting apparatus 22 and/or the preprocessing tank 24. The wash water and centrate tank 52 may include sensors, such as a bottom level sensor 53. A wash water pump 52a may be used to supply the wash water from tank 52 to the cutting apparatus 22.

Optionally, if a customer does not have a pre-existing wash water system, components for handling and re-using the liquid centrate may be introduced, such as directing the centrate to a centrate tank 50, having a centrate tank level sensor 50a and a centrate pump 50b. The centrate pump 50b may be configured to, for example, pump the centrate to the long-term manure storage pit 6 (which may be required if the centrifuge is located at a distance from the manure storage pit), or the pump 50b may optionally be configured to supply liquid centrate to the cutting apparatus 22.

### Control System

All of the components of the preprocessing sub-system and the centrifuge sub-system are controlled and electrically powered through a main control panel. Within the main control panel cabinet, the control system may include speed control mechanisms for controlling the speed of one or more motors in the nutrient recovery system, a programmable logic controller (PLC) and other sensor input and output modules need to control the entire system as would be known to a person skilled in the art.

### Preprocessing Sub-System Controls

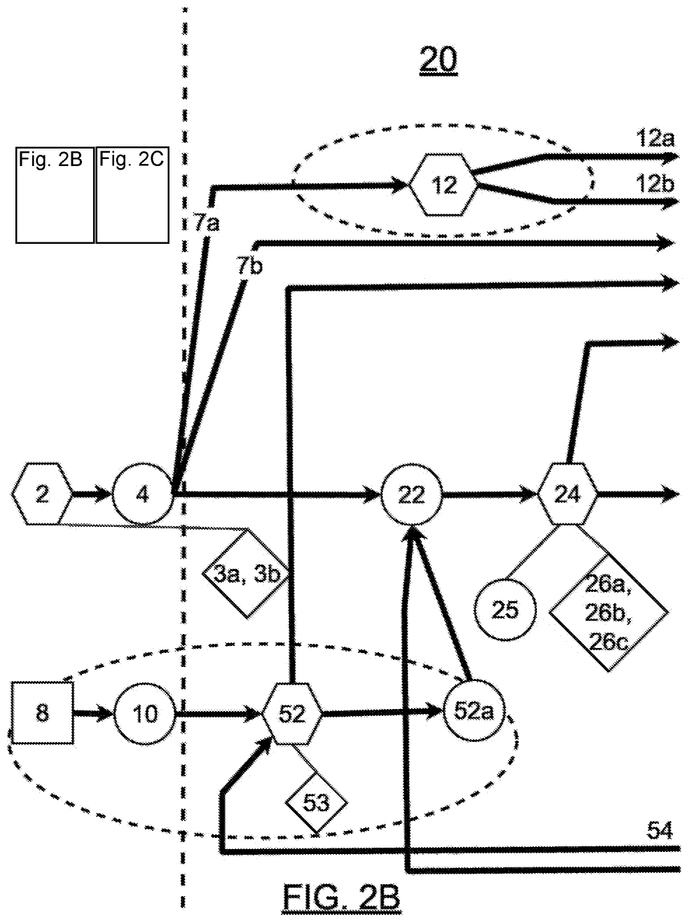

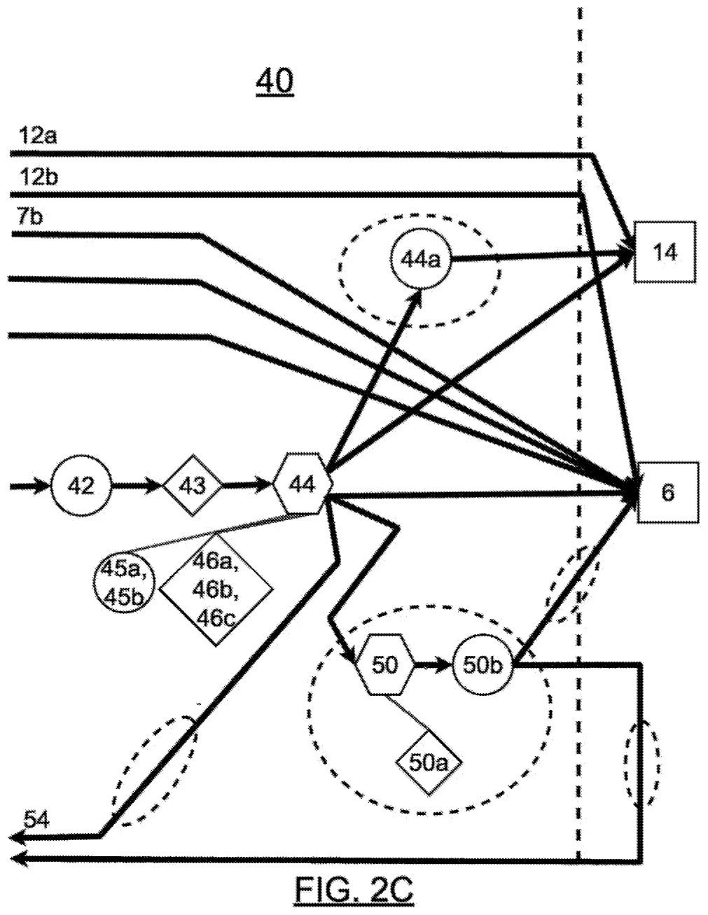

The preprocessing sub-system 20 serves the purpose of connecting with the farm's fresh manure management system, which may be a pre-existing system, and divert the flow of the raw manure through the cutting apparatus which cuts the incoming manure fibers into fine particles, of a uniform desired length, before it is moved into the preprocessing tank. As illustrated in FIGS. 3 and 4, the preprocessing sub-system 20 may be mounted on a skid 1 for ease of transportation and placement on the farm site.

The flow rate of the raw manure entering the cutting apparatus 22, as well as its cutting speed, are optimized at initial installation in order to cut the fibrous material into very small particle sizes. Optimization may be achieved, in some embodiments, by using a VFD for controlling the speed of the raw manure pump motor and adjusting the frequency or speed of the raw manure pump to a VFD of the cutting apparatus that controls the speed of the motor of the cutting apparatus. In other embodiments, a speed control mechanism other than a VFD may be used to control the speed of the manure pump, the cutting apparatus or any other motorized component of the system. For example, without intending to be limiting, speed control mechanisms may include servo drives, PWM controllers, motor controllers, or any other mechanism for controlling the speed of the motor. In some embodiments, hydraulic motors rather than electric motors may be used to drive one or more motorized components of the nutrient recovery system, and the hydraulic motors may be controlled by proportional or servo valves, or any other known mechanism for controlling the speed of a hydraulic motor. As mentioned elsewhere, the manure pump may be a pre-existing piece of equipment on the farm prior to the installation of the nutrient recovery system, or the manure pump may be a new component installed at the same time as installation of the nutrient recovery system.

In some embodiments, the manure pump may also include a flow meter or other flow measuring device, including but not limited to a mass flow sensor or a Coriolis sensor, to measure or predict the density of the incoming raw manure material. Such a flow meter may be in electronic communication with the control system and may be used to automatically adjust the speed of the manure pump and/or the speed of the cutting apparatus, to optimize the flow of the raw manure through the cutting apparatus by taking into account changes in the density of the raw manure and/or other changes in the characteristics of the raw manure material, such as may occur with changing weather conditions or operating conditions for example.

In an embodiment, the preprocessing system includes the following components: a cutting apparatus (which may be, in some embodiments, an off the shelf rotary cutter or processor, such as the rotary cutter 22 illustrated in FIG. 5), and a preprocessing tank. In some embodiments, the preprocessing tank 24 has a capacity of 16,000 liters, although it will be appreciated that the capacity of the tank is not intended to be limiting. The preprocessing tank also includes an agitator 25 driven by a motor, one or more level sensors for measuring overflow, operating and bottom levels within the tank, and an overflow return line. Optionally, the preprocessing tank 24 includes a fluid inlet 23 for introducing water, wastewater or liquid centrate to the tank.

In an embodiment, the control system includes the following controls for the cutting apparatus: firstly, an anti-jamming detection and prevention function, which monitors motor speed and current (or optionally, torque) of the cutting apparatus motor. If a jam, indicated by high current (or torque) and little or no flow rate, the anti-jamming action is performed whereby the cutting blades are stopped and started several times; if the jam is not cleared, then a fault is generated and the system alerts the operator. The cutting apparatus controls may also include a sharpening function, whereby after a period of running time in one rotational direction, the control system will reverses the rotational direction of the blades, which can sharpen the blades and thereby increase the useful life of this component. Additionally, the control system monitors the preprocessing tank levels, and may stop or slow down the cutting apparatus motor when the level of slurry inside the tank reaches the overflow or upper threshold, and reinitiates or speeds up the cutting apparatus motor when the slurry level inside the tank reaches the bottom or lower level threshold. The control logic may change reinitiate the motor or change the motor speed when a different level is detected, or alternatively, after a set period of time has passed. In some embodiments, once the preprocessing tank is full, the cutting apparatus and the manure pump may be automatically shut off, but the cutting apparatus will stay on for a period of time after the manure pump has shut off so as to automatically clean the cutting apparatus component and prepare for the next feed. When the next feed starts, the cutting apparatus may also be configured to start before raw manure is passed through, so as to clear possible caked on materials remaining in the cutting apparatus. The control system may also be configured to detect when the cutting apparatus motor's current draw (or alternatively, the motor's torque) is not within the acceptable tolerance when raw manure is passing through, indicating that flow of raw manure through the apparatus has stopped. In that case the control system will fault and alert the operator to the issue. The acceptable tolerance limits may be calibrated to be specific to the farming site, which may depend on the characteristics of the raw manure feed particular to that site.

After the raw manure feed passes through the blades and the screen of the cutting apparatus, such as a rotary cutter, the resulting manure slurry exits an outlet of the cutting apparatus and flows into the preprocessing tank. Inside the preprocessing tank, the agitator may continuously mix or agitate the manure slurry to maintain the fibers and other solids in suspension and to homogenize the slurry. Optionally, wash water or liquid centrate (from the decanter centrifuge) may be added to the preprocessing tank when it is desired to adjust the water content of the manure slurry, as explained elsewhere in the present disclosure. In the automatic operation mode, the system will automatically start and stop the manure pump and the cutting apparatus, based on detecting the level of manure slurry in the tank and on monitoring the operation of the manure pump and/or the cutting apparatus, as explained above.

### Centrifuge Sub-System Controls

The centrifuge sub-system is where the separation of the solids and liquids occurs to create two distinct products from the manure slurry. This system draws in the manure slurry that is held in the preprocessing tank and runs it through the decanter centrifuge. The centrifuge sub-system may be operated in manual or automatic mode. In manual mode, the operator may start and stop the motors as needed, unless a fault has been detected. In automatic mode, the system may be started from the off state and fully running as long as the desired operating setpoints are set up.

The centrifuge sub-system may comprise, in one embodiment, the following components: infeed pump, centrifuge inlet flow sensor, and a decanter centrifuge, the decanter centrifuge comprising a main drive, a back drive, a vibration sensor, a liquid exit bearing temperature sensor, a solid exit bearing temperature sensor, a coffin lid proximity sensor, a centrate exit and a solids exit.

The infeed pump draws the manure slurry from the preprocessing tank at a controlled flow rate and supplies it to the decanter centrifuge. The motor of the infeed pump is capable of operating at different speeds, and in some embodiments it may include a variable frequency drive; the speed of the infeed pump motor may be controlled by the control system depending on conditions detected by various different sensors, as well as based on user input parameters.

In manual mode, the operator has local control of the infeed pump for flushing or maintenance purposes. In automatic mode, a process variable for the feed pump flow rate is set to represent the maximum speed of the feed pump and the control system will determine the optimal rate that is at or below that speed.

In an embodiment, the infeed pump controls and functions may include a no flow/cavitation detection function, whereby the flow rate of the infeed pump is monitored, and if no flow rate is detected after a certain period of time, the control system will alert the operator. In some embodiments, outputs of the flow rate meter in conjunction with the status different centrifuge components, including but not limited to the current draw of the main and back drives of the centrifuge and the torque of the bowl and/or the screw of the centrifuge, may be used to determine whether flow is occurring or not. Another function may include pipe and valve unjamming, whereby if no flow detection occurs, the system will stop the infeed pump temporarily before starting it again, which may unjam the conduits feeding the pump. If the unjam feature does not successfully unjam the system, for example after two or three times, the system will fault and alert the operator. If the current draw (or torque) of the main and back drives of the centrifuge indicate that the centrifuge is overloaded, because these values exceed a threshold for a period of time, the infeed pump will turn off, which allows the centrifuge to finish separating the material inside the centrifuge. Once the main and back drive motors of the centrifuge reach acceptable current draw (or torque) thresholds, the feed pump will resume operation.

In some embodiments, the control system may include a material composition compensation function that applies when the system is operating in automatic mode. As explained above, the manure slurry will vary in composition over time as the system operates, which may result in the density of the slurry gradually increasing or decreasing. The material composition function aims to optimize the system by either increasing or decreasing the flow rate of the manure slurry into the centrifuge, depending on the load of the centrifuge as detected, for example, by the main and back drive motor current draws. If the load is under a given threshold, the feed rate is gradually increased until it reaches a pre-set load tolerance level. Similarly, if the centrifuge load is over a given threshold, the feed rate by the infeed pump is gradually decreased until it reaches the pre-set load tolerance level.

The centrifuge flow meter measures the feed rate into the centrifuge, and also measures the temperature of the slurry passed through by the infeed pump. The control system reads these signals and adjusts the infeed pump flow rate as may be required, as well as detecting a no flow condition.

The decanter centrifuge accepts the slurry material from the infeed pump and then separates the material into solid and liquid fractions. The decanter centrifuge comprises a main drive motor, a back drive motor and a number of sensors, such as a vibration sensor (which measures vertical vibration of the centrifuge); a liquid exit bearing temperature sensor (which measures the bearing temperature at the liquid exit), a solid exit bearing temperature sensor (which measures the bearing temperature at the liquid exit) and a coffin lid proximity switch (which monitors whether the coffin lid, which is a portion of the external housing, is open). Some or all of these sensors may communicate signals to the control system, which signals are then used to control the infeed pump motor and the two centrifuge motors.

Both the main and back drive motors can be operated in manual mode or automatic mode. In manual mode the two motors will need to be started and stopped manually, and have their speeds manually set while going through the proper start up procedure. While in automatic mode, the system will sequence starting and stopping these motors before running material through them. The control of the decanter centrifuge may include the following features: cold auto start, which starts the centrifuge from a cold state and sequences the start logic so that even if it has been at rest, the main and back drive motors will warm up and then the infeed pump will start injecting the manure slurry once the main and back drive motors are running at the desired speed; auto safe stop feature includes a sequence for stopping the centrifuge, by first clearing the centrifuge of the manure slurry and then allowing the feed lines to be drained, before a controlled ramp down of the back and main drive motors occurs; automatic takeover and shutdown takeover functions allow the cold auto start or auto safe stop sequences to take over if the system is being operated in manual mode and needs to transition to automatic mode; manual takeover feature allows the operator to interrupt the system from automatic mode and transition to manual mode, whereby the operator can perform quick maintenance procedures (such as, shutting off the infeed pump to clean a pipe), and then allowing the system to transition back to automatic mode; safe fault shutdown feature occurs if the control system detects a centrifuge fault, in which case the control system performs a shutdown procedure in a safe manner and places the centrifuge into a safe state; locked bowl detection feature is where the control system monitors the main and back drive motors for a locked bowl condition, and alerts the operator when such a condition is detected in the centrifuge. The locked bowl occurs when the main and back drive speeds are the same and the differential speed between the two drives are close to zero during normal operation. It is useful to detect a locked bowl condition early, as if the centrifuge operates in a locked bowl condition for a period of time, the system may be plugged by drying out the material too much in the centrifuge, in which case the material becomes stuck inside the centrifuge.

In addition, the following detected conditions will cause the control system to initiate the centrifuge shut down sequence: where the coffin lid is detected to be open when the centrifuge is operating, to protect the safety of people near the centrifuge; three different vibration thresholds, linked to three different time durations, where if any of these three vibration thresholds are reached a vibration fault will occur and the shut down sequence will be initiated by the control system; if either of the solids exit bearing or the liquid exit bearing exceeds a temperature threshold, the shut down sequence will be initiated by the control system; and if an auger is installed in the decanter centrifuge, the main and back drive motors will not be able to start if the auger has not already started or has faulted, which protects the system from plugging at the solids exit.

What is claimed is:

1. A nutrient recovery system for extracting at least one nutrient from raw manure, the raw manure transferred from a manure reception pit into the system by a manure pump, the system comprising:
a cutting apparatus having an inlet in fluid communication with the manure pump and an outlet, the cutting apparatus for cutting fibers of the raw manure to a desired length so as to generate a manure slurry,
the outlet of the cutting apparatus in fluid communication with an inlet of a preprocessing tank, the preprocessing tank for receiving the manure slurry and comprising an agitator for homogenizing the manure slurry in the preprocessing tank,
an infeed pump in fluid communication with an outlet of the preprocessing tank, the infeed pump for transferring the manure slurry from the preprocessing tank to a decanter centrifuge, the decanter centrifuge having at least one solid outlet for directing a solid cake of the manure slurry into a solids receptacle and at least one liquid outlet for directing a liquid centrate of the manure slurry into a liquid receptacle,
a control system comprising a plurality of controllers and sensors, the control system for controlling at least a flow rate of the manure slurry entering the decanter centrifuge and for controlling the operation of motorized components of the system including the manure pump, the cutting apparatus, the infeed pump and the centrifuge to avoid blockages or overloading of any component of the system,
wherein a nutrient content of the at least one nutrient in the liquid centrate is decreased as compared to the raw manure.

2. The system of claim 1, wherein the at least one nutrient is selected from a group comprising:
phosphorous, potassium, calcium, fine organic solids.

3. The system of claim 1, wherein the at least one nutrient includes phosphorous and wherein a phosphorous content of the liquid centrate is decreased by at least 50% by volume as compared to the raw manure.

4. The system of claim 1, wherein the desired length of the fiber is in the range of 0.0625 inches to 1 inch.

5. The system of claim 1 wherein the cutting apparatus includes a motor controlled by a speed control mechanism, the speed control mechanism in electronic communication with the control system, wherein a speed of the cutting apparatus motor is adjusted by the cutting apparatus speed control mechanism based on a load of the cutting apparatus, the load of the cutting apparatus detected by the control system by monitoring a status of the cutting apparatus motor.

6. The system of claim 5, wherein the monitoring of the status of the cutting apparatus motor is selected from a group comprising: monitoring the current draw of the cutting apparatus motor, monitoring the torque of the motor.

7. The system of claim 1, wherein the infeed pump comprises an infeed pump motor controlled by an infeed speed control mechanism, the infeed speed control mechanism in electronic communication with the control system, wherein when the control system detects a higher load on the decanter centrifuge the infeed speed control mechanism gradually decreases the infeed motor frequency to decrease the flow rate of the manure slurry into the decanter centrifuge, and wherein when the control system detects a decreased load on the decanter centrifuge the infeed speed control mechanism gradually increases the infeed pump motor frequency to increase the flow rate of the manure slurry into the decanter centrifuge, so as to compensate for variations in manure slurry viscosity.

8. The system of claim 8 wherein the preprocessing tank includes a fluid inlet for introducing water or liquid centrate to the preprocessing tank and a level sensor for measuring an amount of manure slurry contained in the preprocessing tank, the level sensor in electronic communication with the control system, wherein when the load on the decanter centrifuge exceeds a threshold, the control system introduces water or liquid centrate to the preprocessing tank through the fluid inlet so as to decrease the viscosity of the manure slurry entering the decanter centrifuge.

9. The system of claim 8, wherein the infeed speed control mechanism is a variable frequency drive (VFD).

10. The system of claim 5, wherein the preprocessing tank includes a level sensor for includes a level sensor for measuring an amount of manure slurry contained in the preprocessing tank, the level sensor in electronic communication with the control system, and wherein when the level sensor detects the amount of manure slurry in the preprocessing tank is below a lower threshold the control system initiates the manure pump and cutting apparatus, and wherein when the level sensor detects the amount of manure slurry in the preprocessing tank is above an upper threshold the control system stops the manure pump and the cutting apparatus.

11. The system of claim 1, wherein the cutting apparatus is selected from a group comprising: a rotary cutter, a grinder, a macerator.

12. The system of claim 1, wherein the manure pump includes a motor controlled by a manure pump speed control mechanism and a flow meter, and the cutting apparatus is controlled by a cutting apparatus speed control mechanism, and wherein a flow rate of the raw manure entering the cutting apparatus is controlled by adjusting a speed of the manure pump motor to correspond to the speed of the rotary cutter motor.

13. The system of claim 12, wherein the preprocessing tank includes a level sensor for measuring an amount of manure slurry contained in the preprocessing tank, the level sensor in electronic communication with the control system, wherein the manure pump speed control mechanism increases the speed of the manure pump motor when the level sensor detects the amount of manure slurry in the preprocessing tank is below a lower threshold, and wherein the manure pump speed control apparatus decreases the speed of the manure pump motor when the level sensor detects the amount of manure slurry in the preprocessing tank exceeds an upper threshold.

14. The system of claim 13, wherein the lower threshold of the level sensor is set at a first height measured from a floor of the preprocessing tank, wherein the first height extends above a blade height of the agitator, the blade height measured from the floor of the preprocessing tank to the upper surface of the agitator, and wherein the upper threshold of the level sensor is set at a second height measured from the floor of the preprocessing tank, wherein the second height is greater than the first height and less than a total height of the preprocessing tank.

15. The system of claim 1, wherein the control system further comprises a centrifuge overcurrent detector, wherein the centrifuge overcurrent detector monitors a main drive current of a centrifuge main drive motor and a back drive current of a centrifuge back drive motor of the decanter centrifuge, and wherein when the main drive current or the back drive current exceeds a centrifuge current threshold, the control system temporarily stops the infeed pump until the manure slurry in the centrifuge has exited the centrifuge, at which time the control system reinitiates the infeed pump.

16. A method for extracting at least one nutrient from raw manure, the raw manure transferred from a manure reception pit into the system by a manure pump, the method comprising:
transferring raw manure to a cutting apparatus, the cutting apparatus having an inlet in fluid communication with the manure pump and an outlet, the cutting apparatus for cutting fibers of the raw manure to a desired length so as to generate a manure slurry,
transferring the manure slurry to a preprocessing tank, the preprocessing tank comprising an agitator for homogenizing the manure slurry in the preprocessing tank,
transferring the homogenized manure slurry via an infeed pump to a decanter centrifuge, the decanter centrifuge having at least one solid outlet for directing a solid cake of the manure slurry into a solids receptacle and at least one liquid outlet for directing a liquid centrate of the manure slurry into a liquid receptacle,
controlling at least a flow rate of the manure slurry through the infeed pump to the decanter centrifuge by a control system so as to prevent blockage or jamming of the decanter centrifuge, and
wherein a nutrient content of the at least one nutrient in the liquid centrate is decreased as compared to the raw manure.

17. The method of claim 16, wherein the method further comprises the step of controlling a level of manure slurry inside the preprocessing tank by detecting the said level of manure slurry inside the tank, using a level sensor, and turning on the cutting apparatus motor and the manure pump motor by the control system when the detected level of manure slurry inside the tank is below a lower threshold and turning off the cutting apparatus motor and the manure pump motor by the control system when the detected level of manure slurry inside the tank is above an upper threshold.
